(19) United States
(12) Patent Application Publication
(10) Pub. No.: US 2015/0023124 A1
(43) Pub. Date: Jan. 22, 2015

(54) CONTINUOUS DOUGH KNEADING MACHING FOR PASTRY OR BREAD MIXES, SUCH AS FOR SANDWICH BREAD

(71) Applicant: VMI, Montaigu (FR)

(72) Inventors: Jose Cheio De Oliveira, St Hilaire de Loulay (FR); Dominique Dugast, Remouille (FR); Philippe Coppenolle, Montaigu (FR); Emmanuel Chaillou, Le Fenouiller (FR); Pascal Ricard, Treize Septiers (FR)

(21) Appl. No.: 14/383,499

(22) PCT Filed: Feb. 28, 2013
(86) PCT No.: PCT/FR2013/050427

§ 371 Date: Sep. 5, 2014

(30) Foreign Application Priority Data
Mar. 5, 2012 (FR) 1251981

(51) Int. Cl. A21C 1/06; B01F 15/02; A47J 43/08

(52) U.S. Cl. CPC A21C 1/065; A47J 43/08; B01F 15/0251; B01F 2215/0011; B01F 2015/0204
USPC 366/76.3; 366/91

(57) ABSTRACT

The invention relates to a continuous dough kneading machine for pastry or bread mixes, such as for sandwich bread, said machine comprising: a substantially tubular chamber (C) provided with an inlet (E) for the dough to be kneaded and an outlet (S) for the kneaded dough, including a constriction, said chamber (C) comprising an upstream sub-chamber (C1) connected to the inlet (E) and a downstream sub-chamber (C2) connected to the outlet (S); means (P, V) for creating a negative pressure in the downstream sub-chamber (C2); and two shafts (1a, 1b) rotatably mounted inside the chamber (C), supporting dough-conveying members (5a, 5b) disposed in particular in the upstream chamber (C1) and dough-kneading members (7a, 7b, 9a, 9b) disposed in particular in the downstream chamber (C2). The machine also comprises means (1a, 1b, 11a, 11b) for forming a dough obstruction (B1) in the transition zone from the upstream chamber to the downstream chamber.

### TECHNICAL FIELD

The present invention relates to the field of industrial bakery/confectionery, and concerns a kneading machine for sandwich bread dough.

### BACKGROUND

As it is known per se, kneading allows rolling out the proteins found in the flour, in order to turn them into entangled filaments capable of trapping the gases originating from the fermentation caused by the yeasts.

In order to make sandwich bread, it is sought to obtain the highest density of bubbles in the crumb, that is to say the smallest possible bubbles with the finest possible walls.

To attain this result, it is known from the prior art dough kneading machines intended for making sandwich bread, in which the kneading is carried out under vacuum: such machines marketed in particular under the Tweedy® brand by the British company APV Baker (www.apvbaker.com), typically comprising kneading tanks in which the dough to be kneaded is introduced in batches, and means for creating vacuum in the tank during kneading.

It appears in fact that the vacuum kneading makes it possible to reduce the size and increase the concentration of gas bubbles generated by the fermentation of the dough: in fact, the presence of vacuum makes it possible to tighten the mesh formed by the proteins rolled out from the flour, and thus to prevent the gas bubbles of very small size resulting from fermentation escaping from the dough.

Although satisfactory, this batch kneading method exhibits limitations inherent to its discontinuous character: in particular, very high production rates cannot be achieved.

With regard to high production-rate kneading of dough for industrial bakery/confectionery, different continuous kneading machines are known: the ingredients, such as flour and water in the case of the manufacture of bread dough, continuously arrive inside a mixer or milling machine, so as to form a paste which then falls inside a tank equipped with one or several worm drives. When turning, these drives knead the dough which continuously advances towards an outlet end of the tank.

However, these kneading machines are unsuitable for continuous vacuum kneading, due to the various air passages that exist in particular, at the inlet and outlet of these machines, and which are inherent to the design of these machines.

### BRIEF SUMMARY

Thus, the purpose of the present invention is in particular, to make a continuous kneading machine suitable for the kneading of sandwich bread dough.

This purpose of the invention is attained, as well as other purposes which will become apparent upon reading the following description, with a continuous dough kneading machine for bread or pastry mixes such as sandwich bread, comprising:
a substantially tubular chamber equipped with an inlet for the dough to be kneaded and an outlet for the kneaded dough, exhibiting a constriction, said chamber comprising an upstream sub-chamber communicating with said inlet, and a downstream sub-chamber communicating with said outlet,
means for creating negative pressure in said downstream sub-chamber,
two shafts rotatably mounted inside said chamber, supporting members for conveying said dough, disposed in particular, in said upstream chamber, and members for kneading said dough, disposed in particular, in said downstream chamber,
said machine comprising means for forming a dough obstruction in the transition area from said upstream chamber to said downstream chamber.

Thanks to these features, the dough to be kneaded sealingly obstructs both the inlet and outlet (due to the constriction) of the downstream sub-chamber, so that the negative pressure means allow achieving vacuum inside this sub-chamber.

It is therefore possible to knead the dough continuously and under vacuum, which allows obtaining in particular sandwich bread dough at high production rates.

According to other optional features of the present invention:
said conveying members have a lower pitch than said kneading members;
said means for forming a dough obstruction comprise a bare shaft area provided between said conveying and kneading members;
said conveying members are worm drives, and said kneading members are kneading plates;
said means for forming a dough obstruction comprise a reverse flighted screw area provided between said conveying and kneading members;
said negative pressure means comprise a threaded bore communicating with said downstream chamber, a screw mounted in said threading with a slight clearance, and air suction means found in this clearance.

### BRIEF DESCRIPTION OF THE DRAWINGS

Other characteristics and advantages of the present invention will become apparent in light of the following description and upon examination of the accompanying figures, in which:

FIGS. 1 and 2 represents views, respectively in axial sectional and cut-away perspective, of a continuous kneading machine according to the invention,

FIG. 3 represents a perspective view of two rotary shafts located inside this machine,

FIG. 4 represents an axial sectional view of a milling machine intended to cooperate with the continuous kneading machine according to the invention, and

FIG. 5 is a perspective view of the mixing shaft of this milling machine.

### DETAILED DESCRIPTION

On all these figures, identical or similar references represent identical or similar members or assemblies of members.

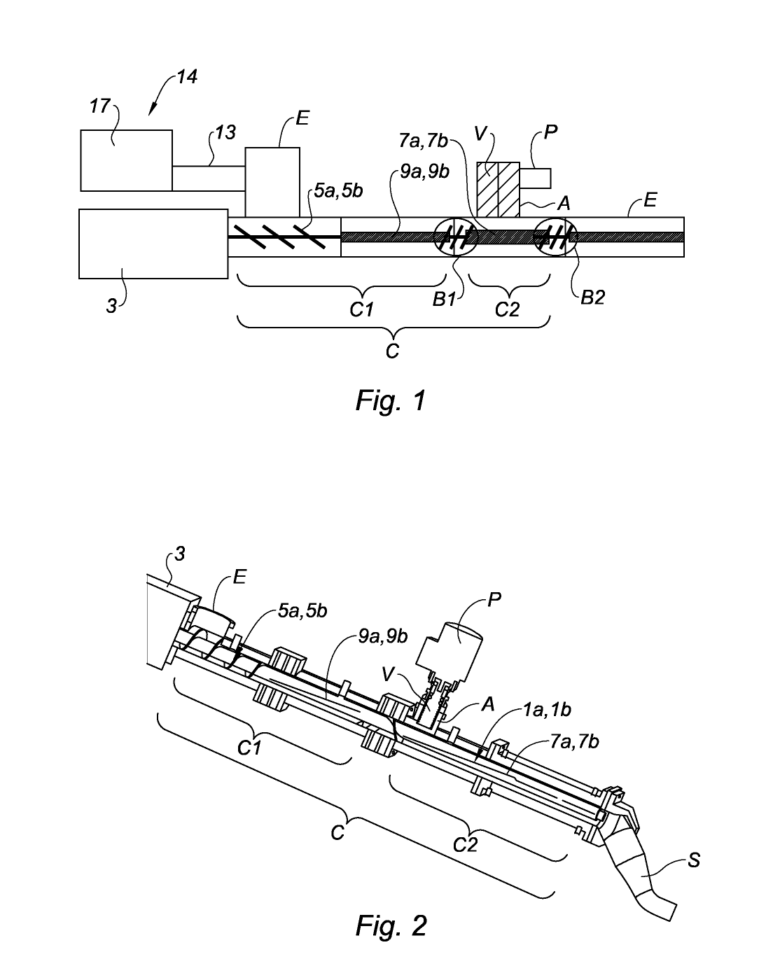

As can be seen on FIGS. 1 and 2, the machine according to the invention comprises a chamber C of substantially tubular section, which can be formed for example of stainless steel.

This chamber C is subdivided into an upstream sub-chamber C1, and into a downstream sub-chamber C2, respectively communicating with an inlet orifice E, and with an outlet orifice S, the latter exhibiting a constriction with respect to the section of chamber C.

A threaded bore A communicates with the sub-chamber C2, and a screw V is mounted in the threading of this bore A with a slight clearance.

A vacuum pump P connected to the bore A allows sucking the air that is found in the clearance separating the screw V from its bore, and thus creating negative pressure inside the downstream sub-chamber C2.

Inside the chamber C, and extending substantially along the entire length of this chamber, there are two shafts 1a, 1b connected to a geared motor unit 3.

This geared motor unit may be set such as to rotate the two shafts in the same direction, or in the opposite direction.

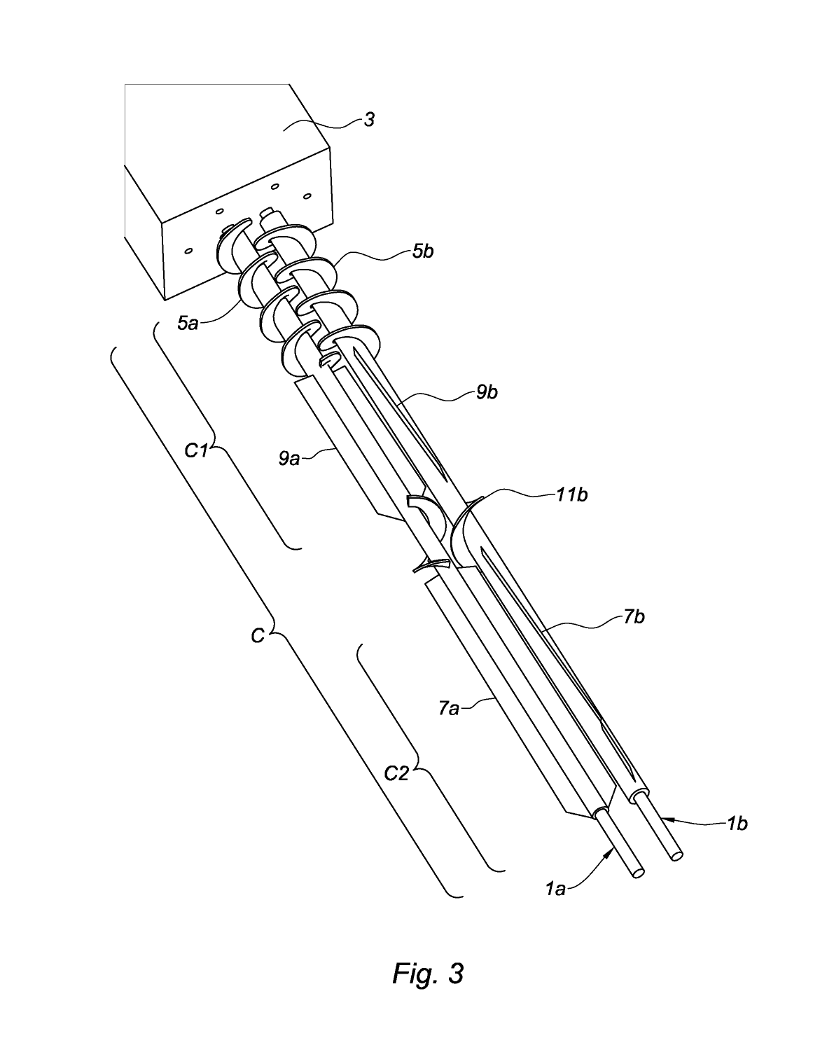

Referring specifically to FIG. 3, it can be seen that each shaft 1a, 1b, supports on the one hand conveying members 5a, 5b, placed in the upstream sub-chamber C1 perpendicular to the inlet E, and on the other hand kneading members 7a, 7b placed in the downstream sub-chamber C2.

The conveying members 5a, 5b, may for example take the shape of worm drives, and the kneading members 7a, 7b, the shape of kneading plates, as shown in FIG. 3.

The general idea is that the conveying members 5a, 5b exhibit a considerably lower pitch than that of the kneading members 7a, 7b, such that these members can ensure their respective conveying and kneading functions.

Optionally, as shown in FIG. 3, it can be provided additional pre-kneading plates 9a, 9b, disposed in the sub-chamber C1 between the conveying members 5a, 5b, and the kneading members 7a, 7b.

It may be further provided, equally and optionally, reverse flighted worm drives 11a, 11b, disposed just upstream of the kneading plates 7a, 7b, that is to say, right at the inlet of the kneading sub-chamber C2.

In an alternative, and non represented manner, the reverse flighted screws 11a, 11b could also be replaced, with areas where the shafts 1a, 1b become bare, that is to say, without any conveying and/or mixing member.

As is known per se, given the significant length of the shafts 1a, 1b (typically between 1.50 m and 2 m), it may be provided one or several bearings inside the chamber C, so as to ensure the correct centering of the rotation of these shafts, and thus, reduce all phenomena of unbalance and vibration.

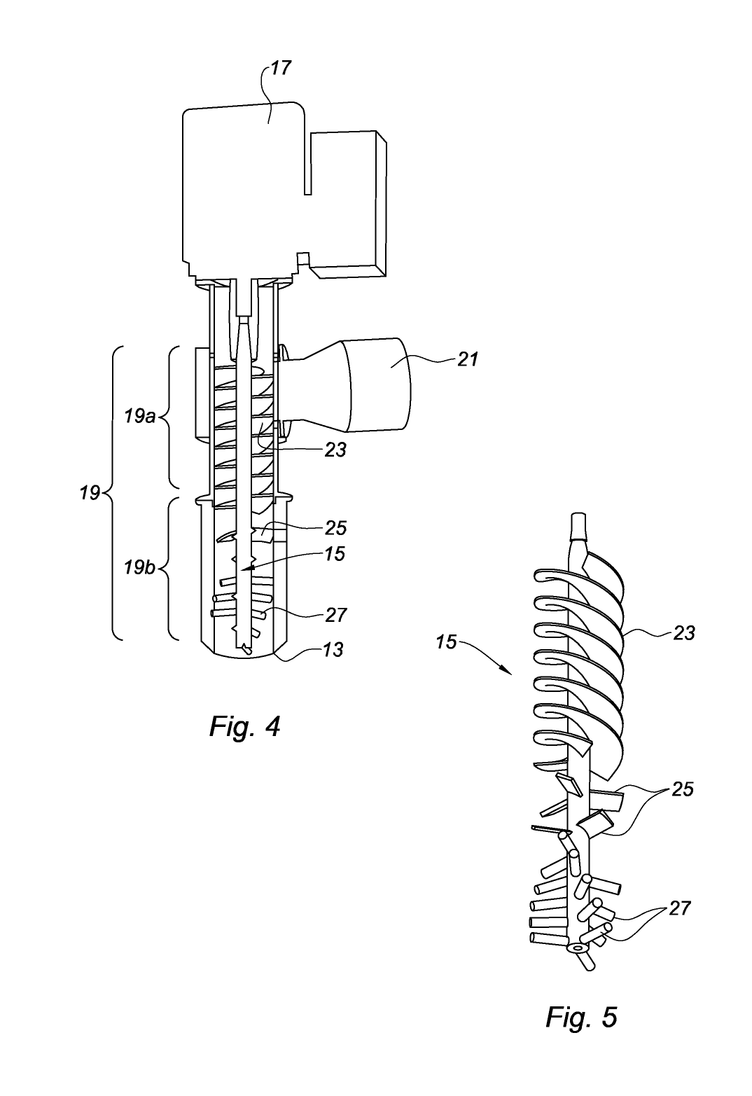

It has been represented on FIGS. 4 and 5 a milling machine, that is to say, an apparatus for pre-mixing flour and one or several liquids such as water, intended to be placed upstream of the kneading machine which has just been described.

More specifically, the outlet 13 of this milling machine is intended to communicate with the inlet E of the machine represented on FIGS. 1 to 3.

This milling machine substantially comprises a mixing shaft 15 drive n by a geared motor 17, able to turn inside a chamber 19 comprising on the one hand a sub-chamber 19a for introducing the flour by an inlet 21, and on the other hand a sub-chamber 19b for introducing liquids such as water, and mixtures of these liquids with the flour.

More specifically, as can be seen on FIG. 5, the mixing shaft 15 comprises, from upstream to downstream in the flow direction of the flour, a conveying member able to take the shape of a worm drive 23, members for dispersing the liquid introduced into the flour, able to take the form of radial blades 25, and members for homogenizing the mixture thus produced, which may comprise radial fingers 27.

The mode of operation and the advantages of the continuous kneading machine according to the invention are a direct result of the above description.

In order to operate this machine, the geared motors 3 and 17 are started up.

The flour is introduced into the inlet 21 of the milling machine 14, which is conveyed to the inside of the sub-chamber 19a thanks to the worm drive 23.

When this flour arrives in the area of introduction of liquid of the milling machine, it is mixed with liquid such as water (and other possible liquid additives), the radial blades 25 ensuring the proper dispersion of this liquid inside the flour.

The radial fingers 27 finalize the mixture thus obtained, which then arrives in the upstream sub-chamber C1 of the kneading machine.

This mixture is conveyed towards the downstream sub-chamber C2 by the two worm drives 5a, 5b, and pre-kneaded by the plates 9a, 9b.

When this mixture arrives on the reverse flighted screws 11a, 11b, it is slowed down, so that a dough obstruction B1 forms at the inlet of the downstream sub-chamber C2.

As furthermore the outlet S of the machine exhibits a constriction with respect to the section of the chamber C, a dough obstruction B2 also forms in this outlet.

Hence, a sealed area between the two dough obstructions B1, B2 is obtained, so that the vacuum pump P makes it possible to achieve the vacuum in the downstream sub-chamber C2.

It is worth noting that the screw V mounted with clearance in its bore A, allows sucking the air by the pump P, without sucking the dough which remains blocked by the screw V at the inlet of the bore A.

The kneading of the dough in the downstream sub-chamber C2 may thus be continuously carried out under vacuum, which is perfectly suitable for obtaining sandwich bread dough, as was stated in the preamble of the present description.

It is worth noting that, according to the embodiment, the two shafts 1a, 1b, can rotate in the same direction or in the opposite direction.

It is also worth noting that it can be provided more than two shafts.

It is also worth noting that it can be provided therein not reverse flighted screws 11a, 11b, between the upstream C1 and downstream C2 sub-chambers, but simple bare areas on the shafts 1a, 1b: the dough obstruction B1 could likewise be obtained, due to the great difference in pitch between the kneading plates 7a, 7b (very high pitch), and those of the worm drives 5a, 5b (considerably lower pitch).

It is understood that the invention allows, in a very simple manner, each shaft 1a, 1b to play a conveying function, a kneading function, and a function of creating a sealed space, by limiting the number of rotating parts and elements.

The continuous kneading machine according to the invention, which is hence of very simple design, is both inexpensive to manufacture and maintain.

It is in particular noteworthy that, due to the fact that it is provided that only one portion of the chamber C is under negative pressure, the in-process production can be considerably limited, that is to say, the quantity of dough lost at the end of each production cycle.

In fact, only a quantity of dough equivalent to the capacity of the downstream sub-chamber C2 is to be thrown out, thus minimizing losses.

By way of indication, the respective lengths of the upstream C1 and downstream C2 sub-chambers can be 60% and 40%.

Obviously, the present invention is in no way limited to the embodiments described and shown, provided by way of simple examples.

1. A continuous dough kneading machine for pastry or bread mixes such as for sandwich bread, comprising:
a substantially tubular chamber equipped with an inlet for the dough to be kneaded and an outlet for the kneaded dough, exhibiting a constriction, said chamber comprising an upstream sub-chamber communicating with said inlet, and a downstream sub-chamber communicating with said outlet,
means for creating negative pressure in said downstream sub-chamber,
two shafts rotatably mounted inside said chamber, supporting members for conveying said dough, disposed in particular, in said upstream chamber, and members for kneading said dough, disposed in particular, in said downstream chamber,
said machine comprising means for forming a dough obstruction in the transition area from said upstream chamber to said downstream chamber.

2. The machine according to claim 1, in which said conveying members exhibit a lower pitch than said kneading members.

3. The machine according to claim 1, in which said means for forming a dough obstruction comprise a bare shaft area provided between said conveying and kneading members.

4. The machine according to claim 1, in which said conveying members are worm drives, and said kneading members are kneading plates.

5. The machine according to claim 1, in which said means for forming a dough obstruction comprise a reverse flighted worm drive area provided between said conveying and kneading members.

6. The machine according to claim 1, in which said negative pressure means comprise a threaded bore communicating with said downstream chamber, a screw mounted in said threading with a slight clearance, and air suction means found in this clearance.
